(19) United States
(12) Patent Application Publication
(10) Pub. No.: US 2009/0072499 A1
(43) Pub. Date: Mar. 19, 2009

(54) System for centrifugal-force compensation in a hydraulic machining-chuck actuator

(76) Inventor: Georg ROHM, Sontheim (DE)

Correspondence Address: K.F. ROSS P.C., 5683 RIVERDALE AVENUE, SUITE 203 BOX 900, BRONX, NY, 10471-0900, US

(21) Appl. No.: 12/211,902

(22) Filed: Sep. 17, 2008

(30) Foreign Application Priority Data
Sep. 17, 2007 (DE) 102007044297.3

(51) Int. Cl. B23B 31/30; B23B 31/10

(52) U.S. Cl. 279/4.02; 82/1.11

(57) ABSTRACT

A machining apparatus has a chuck rotatable about an axis and having radially displaceable and angularly spaced jaws, a double-acting cylinder having a piston flanked by a pair of separate compartments and operatively connected to the jaws for radially shifting same. One of the compartments is pressurized with a working pressure pressing the jaws against a tool or workpiece and the other of the compartments with a counterpressure opposite to the working pressure. An instantaneous rotation speed of the chuck is detected, and a pressure differential between the working and counterpressures is varied in accordance with the detected instantaneous rotation speed.

### FIELD OF THE INVENTION

The present invention relates to a chuck actuator for a machining apparatus such as a lathe. More particularly this invention concerns a method for compensating the centrifugal force when operating a machining apparatus that has an electric clamping device or actuator, to a determination method for a correlation table for the method for compensating the centrifugal force, and to a machining apparatus that has an electric actuator and that has a centrifugal-force compensating device.

### BACKGROUND OF THE INVENTION

When machining workpieces using conventional machining apparatuses the problem occurs with outside gripping that as speed increases the influence of centrifugal force reduces the instantaneously acting clamping force on the workpiece because the centrifugal force, which increases as the speed increases, acts against the working pressure on the jaws. A higher speed is desired for more rapid workpiece processing so that the above-described problem becomes increasingly important with ever more demanding requirements for speed and efficiency when processing workpieces. At extremely high rotation speeds

In a conventional method for assuring adequate clamping force at higher speeds, the initial clamping force in a conventional machining apparatus is increased so much that the instantaneously acting clamping force is adequate for machining the workpieces, even at higher speeds. However, this conventional method has the disadvantage that the higher the speed is for the machining, the more the initial clamping force must be increased. The increased initial clamping force is applied both at the beginning of the clamping process prior to the speed increasing and also at the end of the clamping process when the speed on the workpieces is reduced. Thus this method has the disadvantage that workpieces made of materials that are sensitive to deformation are damaged due to the increased initial clamping force at the beginning of the clamping process and/or at the end of the clamping process.

Another conventional method for assuring adequate clamping force at higher speeds uses mechanical centrifugal force compensation. The disadvantage of an elevated initial clamping force is avoided in this manner. However, this method has the disadvantage of so-called clamping force hysteresis. When braking from a high speed, clamping force hysteresis leads to a markedly higher clamping force than at the beginning of the clamping process. Thus the method having mechanical centrifugal force compensation and the machining apparatus having mechanical centrifugal force compensation have the disadvantage that, once again, workpieces made of materials that are sensitive to deformation are damaged at the end of the clamping process.

### OBJECTS OF THE INVENTION

It is therefore an object of the present invention to provide an improved actuator-control system for a chuck of a machining apparatus.

Another object is the provision of such an improved actuator-control system for a machining apparatus that overcomes the above-given disadvantages, in particular that automatically adjusts the clamping force applied by the chuck actuator in accordance with the instantaneous rotation speed of the chuck.

### SUMMARY OF THE INVENTION

A machining apparatus has a chuck rotatable about an axis and having radially displaceable and angularly spaced jaws, a double-acting cylinder having a piston flanked by a pair of separate compartments and operatively connected to the jaws for radially shifting same. One of the compartments is pressurized with a working pressure pressing the jaws against a tool or workpiece and the other of the compartments with a counterpressure opposite to the working pressure. According to the invention an instantaneous rotation speed of the chuck is detected, and a pressure differential between the working and counterpressures is varied in accordance with the detected instantaneous rotation speed. The use of a double-acting cylinder provides the advantage that a given clamping force is maintained with only minor deviations over a broad range of speeds. This is particularly advantageous for more rapid machining, especially for materials that are sensitive to deformation such as for instance bearing rings or other thin-walled workpieces that require low-deformation clamping.

Thus the counterpressure that is conventionally used only for releasing the workpieces from the chuck may also be varied during processing of the workpieces in order to compensate for the reduction in the clamping force on the workpieces when the speed increases. Alternatively and/or in addition, the working pressure may be varied in order to compensate for the reduction in the clamping force on the workpieces when the speed increases.

In one preferred illustrated embodiment, a pressure reducer is arranged in one of the pressure medium lines in the machining apparatus. This has the advantage that the pressure is varied in a simple manner. Moreover, a pressure reducer may be arranged in both pressure medium lines. Thus both a change in the counterpressure and also a change in the working pressure are used in a simple manner for adjusting the pressure difference.

At least one sensor is advantageously arranged in a chuck jaw in the machining apparatus, the sensor being configured for measuring the effective centrifugal force-dependent clamping force. This has the advantage that the changes in the effective centrifugal force-dependent clamping force may be measured, and where necessary corrected as a function of the speed during machining.

The method step of controlling the pressure difference between the working pressure and the counterpressure as a function of the instantaneous speed of the chuck may include a method step of changing the counterpressure as a function of the instantaneous speed of the chuck and/or a method step of changing the working pressure as a function of the instantaneous speed of the chuck. This assures that the pre-specified clamping force may be maintained on the workpieces over a broad range of speeds.

Another feature of the method of this invention are the steps of selecting from a correlation table at least one correlation value of the counterpressure or working pressure for the pre-specified speed of the chuck and supplying the selected correlation value of the counterpressure to a counterpressure or working-pressure adjusting device for the chuck. The use of a correlation table has the advantage that the necessary counterpressure or the necessary working pressure is determined for the specific speed in a simple and rapid manner. The correlation table may be determined for each machining apparatus individually or just once for all machining apparatuses in a model series.

The correlation table advantageously contains at least a first subtable for use when increasing the speed of the chuck and at least a second subtable for use when reducing the speed of the chuck. Thus the influences of friction, which have different influences on the centrifugal force when speeding up and when slowing down, are factored in.

The first subtable and the second subtable are preferably selected as a function of the clamping diameter and/or the material to be machined. This has the advantage that the method is optimized with respect to the required constancy of the effective centrifugal force-dependent clamping force and accelerated machining as a function of the clamping diameter and/or the material to be machined.

The method for operating the machining apparatus may be performed particularly rapidly when the correlation table has correlation values for the counterpressure or for the working pressure in the clamping cylinder for a speed interval of 500 revolutions/minute (rpm) for a range of speeds from 0 to 10,000 rpm. In terms of the constancy of the effective centrifugal force-dependent clamping force, it is advantageous for the method for operating the machining apparatus when the speed interval for the correlation values is 100 rpm, preferably 20 rpm, and in particular 10 rpm, and the range of speeds is 0 to 8,000 rpm, preferably 0 to 5,000 rpm, and in particular 0 to 3600 rpm.

One preferred illustrated embodiment of the method for operating the machining apparatus has the step of detecting an effective centrifugal force-dependent clamping force by means of at least one sensor associated with a chuck jaw and the step of regulating the counterpressure or the working pressure as a function of the sensor data. Thus the changes in the effective centrifugal force-dependent clamping force are measured, and where necessary corrected, as a function of the speed during machining. If it is also possible to use a correlation table, this has the advantage that the method can continue to be operated despite potential failure of the sensor.

Moreover, in the method for operating the machining apparatus, the initial value of the clamping force may be adjusted to the required clamping force increased by the regulating interval.

In an inventive determination method for a correlation table for the above-described method for operating the machining apparatus for at least one speed of the chuck a correlation value of a counterpressure in the clamping cylinder or a correlation value of a working pressure in the clamping cylinder is determined such that the influence of the centrifugal force on the clamping force is reduced for this speed. Thus the effective centrifugal force-dependent clamping force is maintained over a broad range of speeds within the required constancy.

Preferably during the determination method for the correlation table at least a first subtable is determined for increasing the speed of the chuck and at least a second subtable is determined for reducing the speed of the chuck. Thus the different influences of friction on the effective centrifugal force-dependent clamping force may be factored into the increase and decrease in speed.

Another aspect of the invention relates to a storage medium, e.g. a CD-ROM, having a correlation table that was determined according to one of the above-described determination methods. This has the advantage that for instance a new correlation table that is adapted to different materials of the workpieces or to another type of machining may be transferred in a simple manner to machining apparatuses in accordance with the invention.

One additional aspect of the present invention relates to a storage medium having a computer program for performing one of the above-described methods for operating a machining apparatus. Thus, firstly, machining apparatuses in accordance with the invention may be improved and, secondly, even conventional machining apparatuses may be retrofitted in accordance with the invention.

The present invention furthermore also relates to retrofitting conventional machining apparatuses. It is particularly advantageous that centrifugal force compensation can be done by control of the working pressure and of the counterpressure.

Another aspect of the present invention relates to a storage medium having a computer program for performing one of the above-described determination methods for the correlation table. This has the advantage that it is possible in a simple manner to use the determination method on different machining apparatuses.

### BRIEF DESCRIPTION OF THE DRAWING

The above and other objects, features, and advantages will become more readily apparent from the following description, reference being made to the accompanying drawing in which:

FIG. 1 is a small-scale side view largely in axial section through the machining apparatus according to the invention;

FIG. 2 is a front end view of the chuck of the apparatus;

FIG. 3 is an axial section through the chuck;

FIG. 4 is a largely axially sectional view of the chuck actuator according to the invention;

FIG. 5 is a diagram illustrating a prior-art system; and

FIG. 6 is a diagram like FIG. 5 but illustrating the instant invention.

### SPECIFIC DESCRIPTION

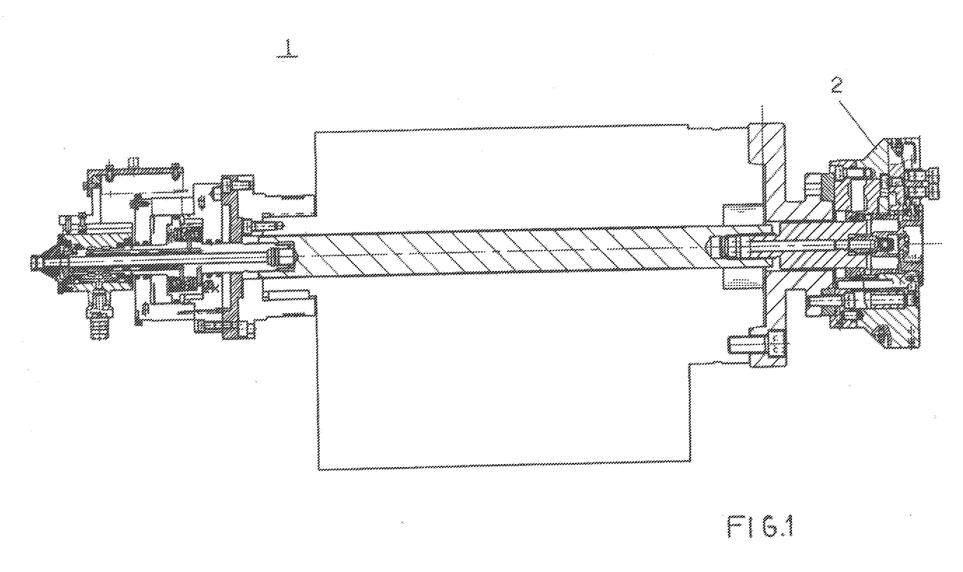

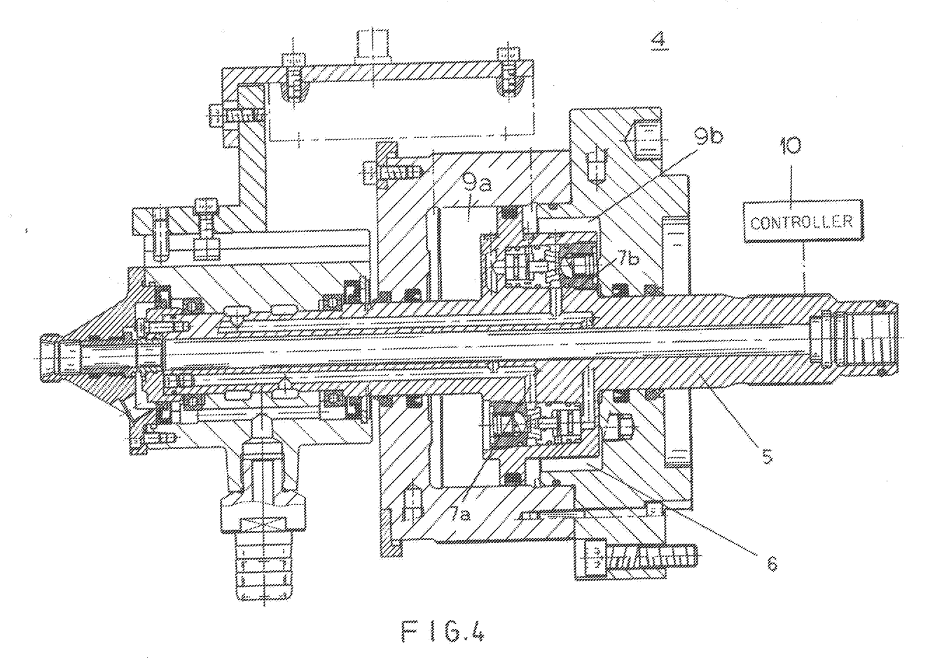

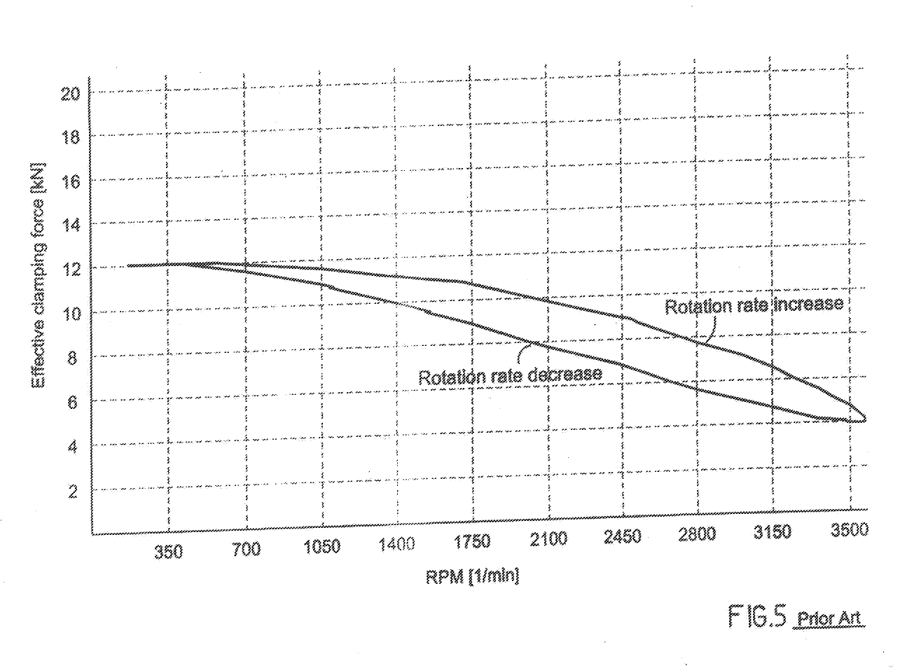

As seen in FIGS. 1-3 a machining apparatus 1 has a chuck 2 with jaws 3 and a chuck body 8 that can be moved radially of a chuck-rotation axis A by a cylinder 4 (FIG. 4) having a piston 5 slidable axially in a cylinder chamber 6. Two pressure medium lines 7a and 7b open into respective compartments 9a and 9b axially flanking the piston 5 in order to supply pressure medium to the cylinder piston 5. The machining apparatus 1 moreover has a controller 10 for applying a pressure differential between a working pressure in the back compartment 9b and a counterpressure in the front compartment 9a as a function of the instantaneous speed of the chuck 2.

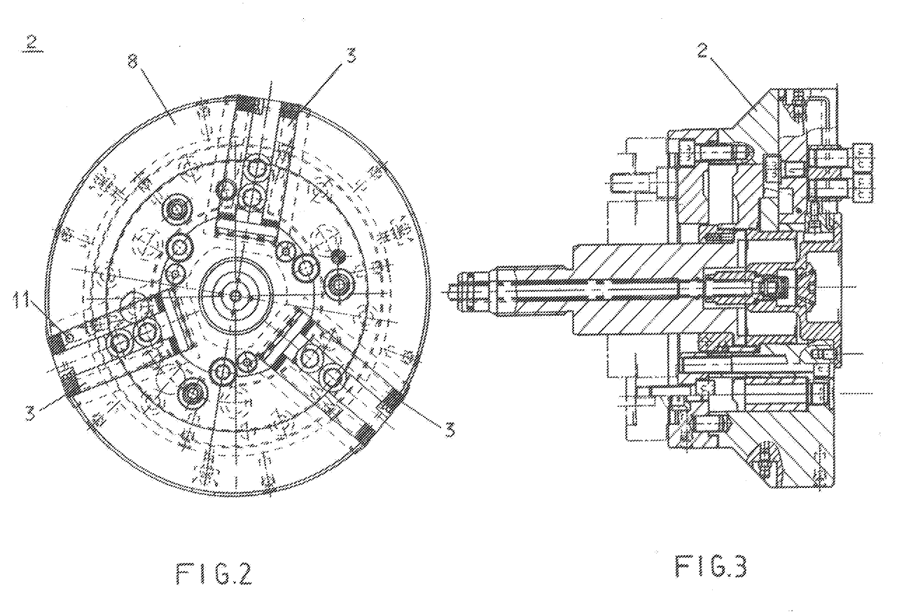

The machining apparatus 1 may have a pressure reducer in one of the pressure medium lines 7a and 7b. The machining apparatus preferably contains at least one sensor 11 (FIG. 2 only) that is mounted in or on at least one chuck jaw 3. The sensor 11 is configured for measuring the effective centrifugal force-dependent clamping force.

FIG. 5 shows how the effective centrifugal force-dependent clamping force is a function of the speed of the chuck 2 in a prior-art machining apparatus without centrifugal force compensation. Due to the centrifugal force, the initial clamping force of 12.1 kn drops to 3.7 kn as the speed of the chuck increases to 3,500 revolutions per minute (rpm). Consequently accurate machining of the workpieces is no longer assured when the chuck 2 is at higher speeds. However, the initial clamping force cannot be increased so much that a centrifugal force-dependent clamping force is assured that is adequately effective at the higher speeds of the chuck 2 that are desired for more rapid processing because in this case the effective centrifugal force-dependent clamping force would be so great at low speeds that workpieces sensitive to deformation could be destroyed.

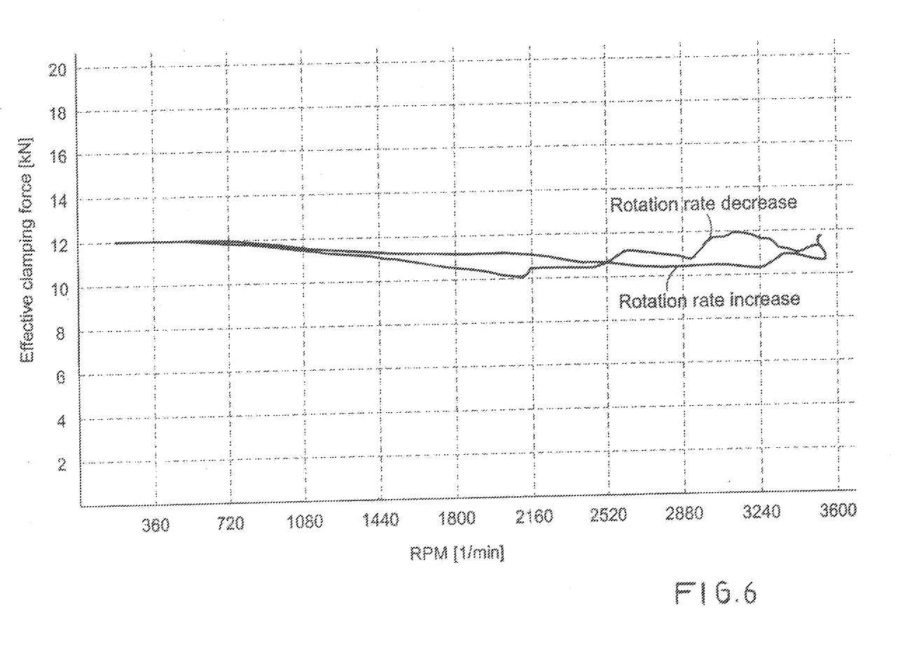

FIG. 6 shows how the effective centrifugal force-dependent clamping force as a function of the speed of the chuck 2 in a machining apparatus 1 that has centrifugal force compensation in accordance with one illustrated embodiment of the present invention. As the speed of the chuck 2 increases, the initial clamping force of 12.0 kn varies in a range of the effective centrifugal force-dependent clamping force of 10.1 kn to 12.0 kn so that secure clamping of the workpieces is assured even when the speed of the chuck 2 is 3,500 revolutions per minute (rpm).

The method for operating a machining apparatus 1 in accordance with one illustrated embodiment of the present invention includes the steps of applying a working pressure on the side of the cylinder piston 5 that acts in the clamping direction, applying a counterpressure on the opposing side of the cylinder piston 5, and controlling a pressure difference between the working pressure and the counterpressure as a function of the instantaneous speed of the chuck 2. The method step of controlling a pressure difference between the working pressure and the counterpressure may can comprise the step of changing the counterpressure as a function of the instantaneous speed of the chuck 2 and/or changing the working pressure as a function of the instantaneous speed of the chuck 2.

The method step of changing the counterpressure in the cylinder chamber 6 with the speed of the chuck 2 may be done by selecting from a correlation table at least one correlation value of the counterpressure for the pre-specified speed of the chuck 2 and supplying the selected correlation value of the counterpressure to a counterpressure adjusting device for the chuck 2. Instead of the counterpressure, the working pressure can be similarly controlled.

The correlation table preferably has at least a first subtable for use when increasing the speed of the chuck 2 and at least a second subtable for use when reducing the speed of the chuck 2. The first subtable and the second subtable may be selected as a function of the clamping diameter and/or the material to be machined.

In the correlation table, the correlation values for the counterpressure or the working pressure in the clamping cylinder 4 may be determined for a speed range of 500 rpm for a range of speeds from 0 to 10,000 rpm, thus creating 20 ranges. Moreover, in the method for operating a machining apparatus 1 the correlation values may be determined for a speed interval of 100 rpm, preferably 20 rpm, and in particular 10 rpm, and for a range of speeds from 0 to 8000 rpm, preferably 0 to 5000 rpm, and in particular 0 to 3600 rpm.

The method for operating a machining apparatus 1 advantageously also includes the step of detecting an effective centrifugal force-dependent clamping force by means the same or a different associated with a chuck jaw 3 and the step of regulating the counterpressure as a function of the sensor data or a method step of regulating the working pressure as a function of the sensor data.

In the method for operating a machining apparatus 1, preferably the initial value of the clamping force is adjusted to the required clamping force increased by the regulating interval.

In accordance with another aspect of the present invention, a storage medium has a computer program for performing one of the above-described methods for operating a machining apparatus 1.

In one determination method for a correlation table for centrifugal force compensation in a machining apparatus according to one illustrated embodiment of the present invention, a correlation value for a counterpressure in the clamping cylinder 4 or for a working pressure is determined such that the influence of the centrifugal force on the clamping force for this speed is reduced.

In accordance with another aspect of the present invention, a storage medium has a computer program for performing one of the above-described determination methods for the correlation table. Moreover, in accordance with another aspect of the present invention, a storage medium has one of the correlation tables that were determined according to one of the above-described determination methods.

The present invention also relates to retrofitting a conventional machining apparatus to create an inventive machining apparatus 1 having a corresponding control that makes it possible to build up a pressure difference between the working pressure and a counterpressure as a function of the instantaneous speed of the chuck 2.

I claim:

1. A method of operating a machining apparatus having
a chuck rotatable about an axis and having radially displaceable and angularly spaced jaws,
a double-acting cylinder having a piston flanked by a pair of separate compartments and operatively connected to the jaws for radially shifting same, and
means for applying to one of the compartments a working pressure pressing the jaws against a tool or workpiece and to the other of the compartments a counterpressure opposite to the working pressure,
the method comprising the steps of:
detecting an instantaneous rotation speed of the chuck; and
varying a pressure differential between the working and counterpressures in accordance with the detected instantaneous rotation speed.

2. The method defined in claim 1 wherein the differential pressure is varied so as to maintain a generally constant net clamping pressure on a workpiece or tool held by the jaws.

3. The method defined in claim 1 wherein one of the pressures is varied and the other pressure is held generally constant.

4. The method defined in claim 3 wherein the one pressure is the working pressure and the other pressure is the counterpressure.

5. The method defined in claim 3 wherein the one pressure is the counter pressure and the one pressure is the working pressure.

6. The method defined in claim 3, further comprising the steps of:
selecting from a correlation table at least one correlation value of the one pressure for a prespecified speed of the chuck; and
supplying the selected correlation value of the counterpressure to a device for the chuck for adjusting the one pressure.

7. The method defined in claim 6 wherein the correlation table includes at least one first subtable for use when increasing the speed of the chuck and at least one second subtable for use when reducing the speed of the chuck.

8. The method defined in claim 7 wherein the first subtable and the second subtable are selected as a function of the clamping diameter or the material to be machined.

9. The method defined in claim 6 wherein the correlation table has correlation values for the counterpressure or for the working pressure for a speed interval of 500 revolutions/minute (rpm) for a range of speeds from 0 to 10,000 rpm.

10. The method defined in claim 1, further comprising the step of:
detecting an effective centrifugal force-dependent clamping force by means of at least one sensor associated with a chuck jaw; and
controlling the counterpressure as a function of the sensor data.

11. The method defined in claim 1, further comprising the step of
adjusting an initial value of the clamping force to the clamping force required increased by the regulating interval.

12. A machining apparatus comprising:
a chuck rotatable about an axis and having radially displaceable and angularly spaced jaws;
a double-acting cylinder having a piston flanked by a pair of separate compartments and operatively connected to the jaws for radially shifting same;
means for applying to one of the compartments a working pressure pressing the jaws against a tool or workpiece and to the other of the compartments a counterpressure opposite to the working pressure;
sensor means for detecting an instantaneous rotation speed of the chuck; and
control means for varying a pressure differential between the working and counterpressures in accordance with the detected instantaneous rotation speed.

13. The apparatus defined in claim 12 wherein the control means includes a pressure reducer connected to one of the compartments.

14. The apparatus defined in claim 12 wherein the control means includes a pressure reducer connected to both of the compartments.

15. The apparatus defined in claim 13, further comprising
sensor means in one of the chuck jaws for detecting an effective centrifugal force-dependent clamping force.
